(19) United States
(12) Patent Application Publication
(10) Pub. No.: US 2008/0123884 A1
(43) Pub. Date: May 29, 2008

(54) Passive hearing aid device

(76) Inventors: David Donenfeld, Mill Valley, CA (US); Fern S. Orenstein, Mill Valley, CA (US)

Correspondence Address: David Donenfeld, 299 Flamingo Rd, Mill Valley, CA, 94941, US

(21) Appl. No.: 11/507,334

(22) Filed: Aug. 22, 2006

(51) Int. Cl. H04R 25/00

(52) U.S. Cl. 381/313

(57) ABSTRACT

A passive hearing aid device that mechanically receives a greater amount of directional acoustic waves than the unaided ear while suppressing extraneous acoustic waves outside the area of focus. The device includes a pair of parabolic acoustic reflectors that are held onto the user's head by a U shaped headband. Dampening material is affixed to the external surface of each reflector which reduces interference from background noise. Padding material located at the perimeter of each acoustic reflector creates a comfortable sealed sound barrier between the acoustic reflector and the user's head.

### TECHNICAL FIELD

The present invention relates generally to passive hearing aid devices, more particularly to a passive hearing aid device with sound dampening material incorporated to eliminate extraneous sound contamination. The present invention is primarily directed toward enhancing the auditory experience of persons in music halls, concerts or lectures, where the auditory signals are focused toward the listener, however, the invention may be employed to enhance a user's listening capabilities in other listening environments as well.

### BACKGROUND INFORMATION AND DISCUSSION OF RELATED ART

Passive listening devices are well known in the art. Although there are electronic means for amplifying sound waves for a hearing-impaired person, the electronics utilized often introduce extraneous background noise along with the intended signal for amplification. Electronic devices are also expensive for occasional use by persons having normal hearing capabilities. Hearing horns or trumpets were developed very early, but tended to produce a propagation of standing waves in the chamber, causing distortions to the sound waves amplified. These devices are generally inserted into the ear canal and are cumbersome to use. Later devices introduce reflectors intended to either focus sound waves into the ear or provide a larger collection area for sound waves.

U.S. Pat. No. 1,1761,666, to Hinternesch, describes a casing devised to be placed upon the ear of an individual, comprising intake and discharge ends for condensing the sound waves. The structure disclosed to condense the sound waves is a centripetal air passage.

U.S. Pat. No. 4,768,613, to Brown, discloses a pair of reflectors to be supported behind the ears as to increase the effective area of the outer ear and reflect an increased amount of sound energy into the user's ears.

U.S. Pat. No. 5,020,629, to Edmundson, et al., describes a listening enhancement device in which a flat body with an ear hook can be converted to a sound gathering device by engagement of a fastener system located on the body of the device.

U.S. Pat. No. 4,997,056, to Riley, discloses an acoustic device for mechanically reflecting sound waves into the ear in an undistorted and directionally selective manner has a pair of movable acoustic reflectors constructed, configured and mounted to preserve accurately phase, frequency and image information in the sound waves of interest to the front of the user, secured to a headband or helmet in positions that place the focal points of the reflectors beyond the base of the lenses within the user's ear.

While each of these inventions describes an apparatus for either focusing or collecting sound waves, and improves the comfort of the attachment of the device to the user, none incorporate the utilization of sound dampening material to exclude sound from outside of the focus of the device. What is needed is a passive hearing aid device that provides improved sound wave collection and incorporates materials intended to dampen unwanted background sound.

The foregoing patents and prior art devices reflect the current state of the art of which the present inventor is aware. Reference to, and discussion of, these patents is intended to aid in discharging Applicant's acknowledged duty of candor in disclosing information that may be relevant to the examination of prospective claims to the present invention. However, it is respectfully submitted that none of the above-indicated patents disclose, teach, suggest, show, or otherwise render obvious, either singly or when considered in combination, the invention described herein.

### BRIEF SUMMARY OF THE INVENTION

The present invention is a passive hearing aid device that mechanically receives a greater amount of directional acoustic waves than an unaided ear, and that mechanically reflects sound waves into the user's ear or ears without distortion.

It is a further object of this invention to provide a means for reducing interference from background noise through the utilization of sound damping materials in the construction of the device.

It is still a further object of this invention to provide a comfortable interface between the present invention and the user through the use of padding material in the sound reflectors and, through the use of material maintaining a shape memory in a head band for mounting the reflectors to the user's head.

It is yet another object of this invention to utilize the padding material between the sound reflectors and the user's head to trap sound waves within the sound reflectors.

It is still another object of this invention to provide an area for advertising or logos on the head band.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawing wherein:

FIG. 1 is a top, rear perspective of the passive hearing aid device.

FIG. 2 is an exploded perspective view of the sound reflector, showing the placement of sound dampening material and the attachment of the headband.

FIG. 3 is a top down perspective view of the sound reflector.

FIG. 4 is a side view of the sound reflector.

FIG. 5 is a frontal view of the headband.

FIG. 6 is a perspective view from the bottom of the headband.

### DETAILED DESCRIPTION OF THE INVENTION

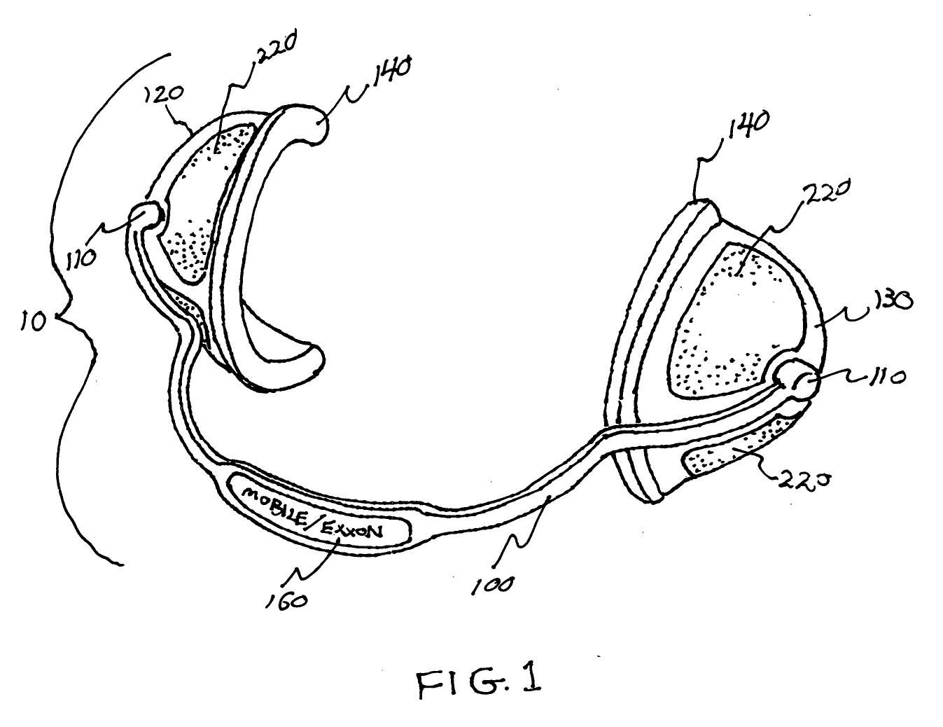

Referring to FIGS. 1 through 6, wherein like reference numerals refer to like components in the various views, there is illustrated therein a new and improved passive hearing aid, generally denominated 10 herein.

FIG. 1 illustrates a first preferred embodiment of the passive hearing aid 10, comprising a headband 100 constructed of a material maintaining a shape memory having a top side and an underside, forming a “U” shaped arc to conform to a user's head, terminating on the left and right ends with snap connectors 110, which are pivotally connected to a left sound reflector 120 and a right sound reflector 130. The left sound reflector 120 and a right sound reflector 130 are each shaped in the form of a parabolic arc having an interior surface and an exterior surface, forming a “C” shaped interface surface surrounding the rear portion of the user's ear, leaving the front of the ear exposed for receiving sound. Foam padding 140 creates a cushion between the left sound reflector 120 and the user, and the right sound reflector 130 and the user. The exterior surfaces of the left sound reflector 120 and a right sound reflector 130 have recessed areas 150 incorporated for insertion of sound dampening material. The headband 100 incorporates a broad, flattened logo recess 160 on its top surface, central to the “U” shape.

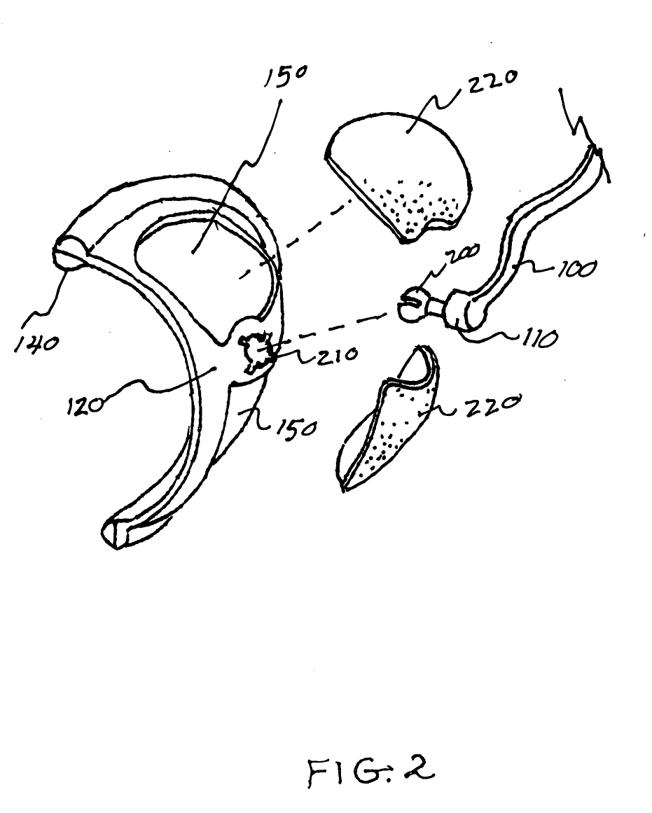

FIG. 2 illustrates the left sound reflector 120 with a detached snap connector 110 showing detail of the snap connector split ball 200 and the receiving socket 210 at the apex of the exterior surface of the parabolic arc formed by the left sound reflector 120. Also depicted is the placement of sound dampening material 220 into the recessed areas 150 on the exterior surface of the parabolic arc formed by the left sound reflector 120.

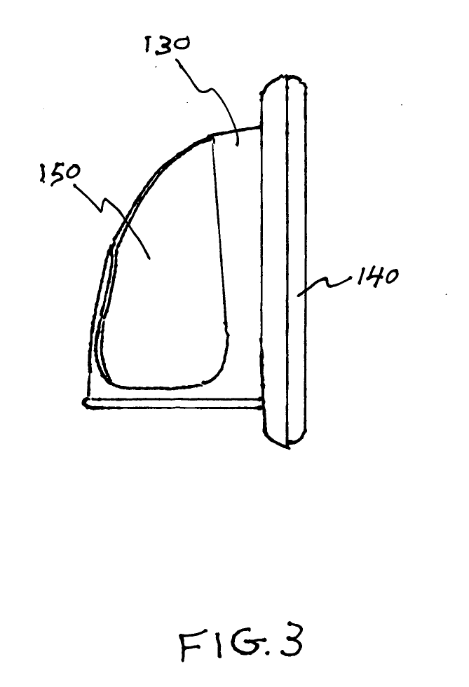

FIG. 3 illustrates the orientation of the right sound reflector 130 and the orientation of the recessed areas 150 on the exterior surface of the parabolic arc formed by the right sound reflector 130. Foam padding 140 covers the interface between the user and the parabolic arc formed by the right sound reflector 130.

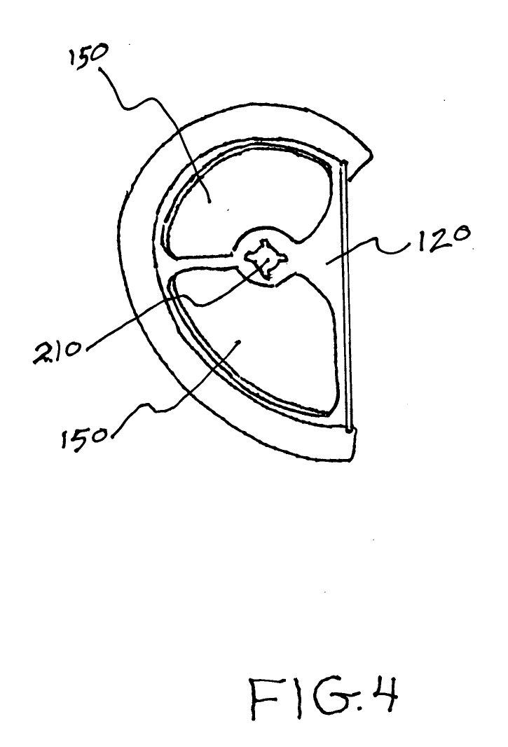

FIG. 4 illustrates the left sound reflector 120 and the placement of the receiving socket 210 at the apex of the exterior surface of the parabolic arc formed by the left sound reflector 120, and the orientation of the areas 150 on the exterior surface of the parabolic arc formed by the left sound reflector 120.

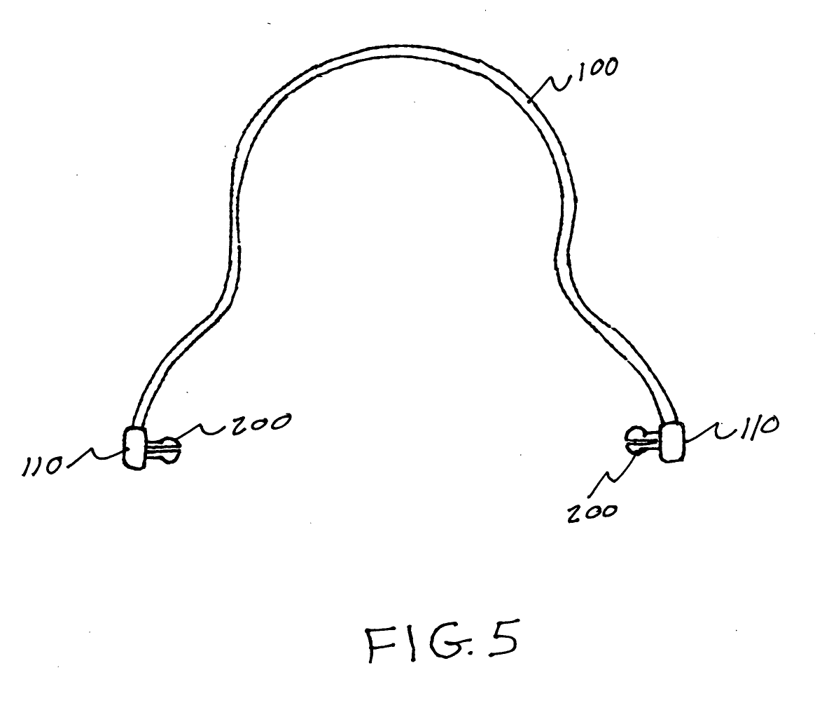

FIG. 5 depicts a front view of the headband 100 with snap connector 110 showing detail of the snap connector split ball 200 at the terminal ends of the headband 100.

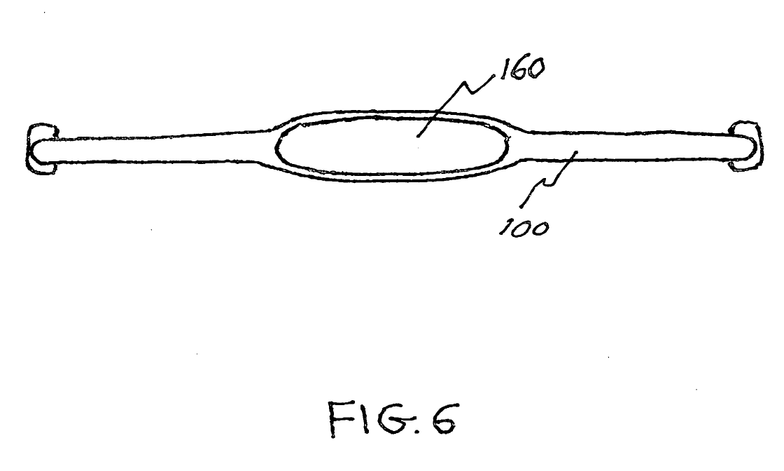

FIG. 6 shows the headband 100 with the orientation of the flattened logo recess 160 on its top surface.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

What is claimed is:

1. A passive hearing aid for aiding in the directional collection of acoustic waves to the ear, while suppressing extraneous acoustic waves outside the area of focus, comprising:
a U shaped headband support means for securing said device to a user's head;
at least one acoustic reflector forming a parabolic arc, having an interior surface and an exterior surface;
at least one pivotal connector to join said acoustic reflector to said headband; and
sound dampening material affixed to the exterior surface of said acoustic reflector.

2. A passive hearing aid device as claimed in claim 1 wherein said headband terminates in a ball structure at each end in said pivotal connecting means; said ball structure capable of being pushed through a centrally located aperture on the surface of said acoustic reflector thereby forming said pivotal connector that allows the perimeter of said acoustic reflector to lay in intimate contact with the user's head.

3. A passive hearing aid device as claimed in claim 1 wherein said sound dampening material is flexible enough to conform the exterior surface of said exterior acoustic reflector surface; said dampening material being preferably made of felt.

4. A passive hearing aid as claimed in claim 1 wherein said headband includes a centrally located widened portion capable of retaining a graphic such as an advertisement or logo.

5. A passive hearing aid as claimed in claim 1 wherein said perimeter of said acoustic reflector that touches a wearers head includes a padded material to trap sound waves within the said acoustic reflector.
